(19) United States
(12) Patent Application Publication
(10) Pub. No.: US 2005/0107896 A1
(43) Pub. Date: May 19, 2005

(54) Remote controlled paint sprayer

(76) Inventors: Glen Kucera, North Haledon, NJ (US); Troy Allen Anderson, Sussex, NJ (US); Hauran Zhu, Livingston, NJ (US); Joseph W. Kieffer, Sparta, NJ (US)

Correspondence Address: KATTEN MUCHIN ZAVIS ROSENMAN, 575 MADISON AVENUE, NEW YORK, NY, 10022-2585, US

(21) Appl. No.: 10/947,068

(22) Filed: Sep. 22, 2004

Related U.S. Application Data
(60) Provisional application No. 60/560,448, filed on Apr. 8, 2004.
(60) Provisional application No. 60/504,875, filed on Sep. 22, 2003.
(60) Provisional application No. 60/542,367, filed on Feb. 6, 2004.

(51) Int. Cl. G05B 13/02; G05B 19/18; B67D 5/08

(52) U.S. Cl. 700/65; 700/66; 700/47

(57) ABSTRACT

A remote control system comprising a transmitter, receiver, and antenna are used to control the functions of a paint sprayer. The system may be retrofit in existing paint sprayers or added during manufacturing. In one embodiment, the remote control system allows a user to control the power and pressure of a paint sprayer. The method of installation and transmission is also described. Alternatively, an add-on unit or digital display may be provided on the remote transmitter.

### BACKGROUND OF THE INVENTION

A. Related Applications

This application is related to provisional applications entitled “Remote Controlled Paint Sprayer”, U.S. Ser. No. 60/560,448, filed Apr. 8, 2004, “Remote Controlled Paint Sprayer”, U.S. Ser. No. 60/504,875, filed Sep. 22, 2003; and “Two Piece Control and Security Lockout”, U.S. Ser. No. 60/542,367, filed Feb. 6, 2004; which are hereby incorporated by reference in their entirety, including any appendices and references thereto.

B. Field of Invention

The present invention relates generally to the field of paint sprayers. More specifically, the present invention is related to controlling a paint sprayer from a distance via remote control and the installation of a receiving device for controlling a paint sprayer from a distance by a transmitting device.

C. Discussion of Prior Art

Pressure controlled paint sprayers utilize pressure as a drive to apply various materials such as paint, stains, and lacquers to structures. Generally, pumps are adapted to pump liquid paint to a pressure such that when a nozzle or spray gun is activated, paint is released.

Contractors, for example, use paint sprayers for painting houses or buildings. The pressurized control system may be used to spray hard-to-reach areas, such as tops of houses, without a substantial amount of effort.

However, accessing the paint sprayer and its controls is problematic. Typically, paint sprayers must be turned off while other tasks are done. The spraying pressure of the paint sprayer needs to be increased to reach the top of peaks and decreased when working around windows and eaves of houses and buildings. Inconveniently, the paint sprayer is typically located distant from the working area. Thus, the user is inconvenienced such that a trade off must be made between convenience and distance.

Having the paint sprayer too distant means having to stop working and walk back to adjust the controls or sacrifice quality for convenience. For example, before being able to climb a ladder or scaffolding, the paint sprayer must be manually turned on, and later manually turned off. Furthermore, a user must climb up and down a ladder or scaffold to adjust the pressure of the sprayer. Climbing up and down structures is not only an inconvenience, but also increases user fatigue.

What is desired therefore is a system that is convenient for users of pressure controlled paint sprayers, i.e. a system for controlling the spraying pressure from a distance. In particular, a remote device that is used to control the power (on and off), the pressure of the paint sprayer, and other functions would be beneficial in the art. Whatever the precise merits, features, and advantages of the prior art, none achieve or fulfill the purposes of the present invention.

### II. SUMMARY OF THE INVENTION

The present invention is a device that allows a user to control at least some functions of a paint sprayer from a distance. Components of the remote controlled paint sprayer comprise at least a receiver, an antenna, and a transmitter.

While such devices are illustrated and described in connection with the control of a paint sprayer per se, it will be understood that other similarly constructed devices may be controlled with equal success. In addition, the remote control system of the present invention is designed to be universal, operating most manufacturer's electronic pressure controlled sprayers.

Further described is a two-piece electronic pressure control with a security lockout feature. More specifically, the present invention comprises a single electronic control device which has a compartment that can be used for a standard version of the control and for an add-on, upgrade version, whereby, an additional interface device fits within the same compartment. A number of functions are provided on the standard version with a considerably greater number of functions on the upgraded version. One feature included on the upgrade version is a security lock out function.

### III. BRIEF DESCRIPTION OF THE DRAWINGS

FIG. 1 illustrates a preferred embodiment of the remote control system for a paint sprayer.

FIG. 2 illustrates a method of attaching the receiver of the present invention to a small paint sprayer housing.

FIG. 3 illustrates a method of attaching a receiver of the present invention to a large paint sprayer housing.

FIGS. 4a and 4b illustrate a detailed view of the installation and connection of the receiver and jump wire to a paint sprayer.

FIG. 5 illustrates a perspective view of a motor shroud for a large paint sprayer housing.

FIG. 6 illustrates a detailed view of components of the transmitter.

FIG. 7 illustrates an embodiment of a transmitter comprising thumb controls that may be associated with a nozzle or spray gun.

FIG. 8 illustrates a block diagram of a preferred microcontroller used with the preferred embodiment.

FIG. 9 illustrates a circuit diagram for the RF transmitter.

FIG. 10 illustrates a circuit diagram for the RF receiver.

FIG. 11 illustrates a perspective view of an alternative standard electronic pressure control transmitter with its cover in the closed position.

FIG. 12 illustrates the control transmitter of FIG. 15 with the cover in the open position and exposing the standard control module.

FIGS. 13a and 13b illustrate block diagrams of the remote and add-on sections of the RF transmitter.

FIG. 14 illustrates an assembly view of the standard control transmitter of FIGS. 14 and 16 with an add-on, upgrade control module.

FIG. 15 illustrates the add-on module mounted to the standard control module.

FIG. 16 is an operational flowchart detailing the decision-making paths of the add-on display control module.

FIG. 17 illustrates a top, front and side view of an alternative embodiment of the remote control transmitter.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

General Description

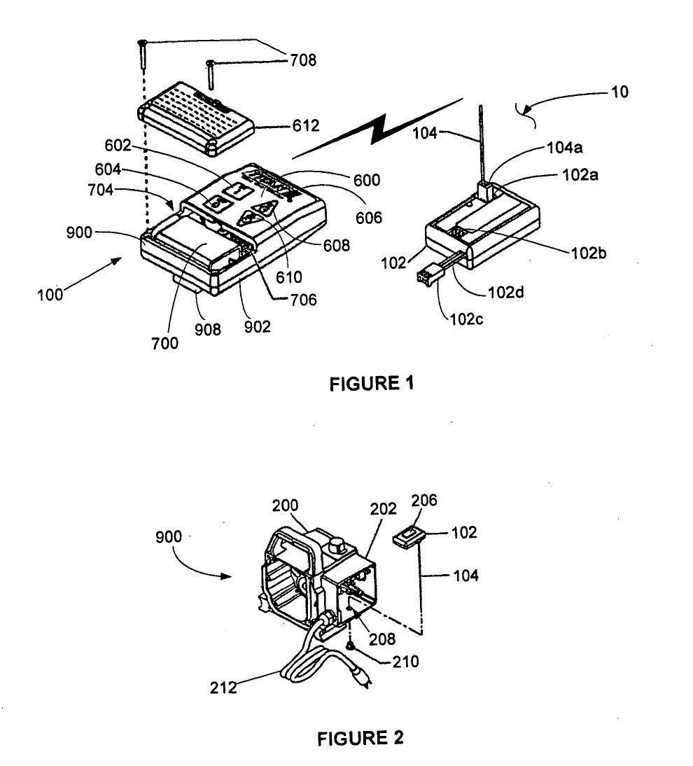

The present invention is a device that allows a user to control at least some functions of a paint sprayer from a distance. FIG. 1 illustrates a preferred embodiment of the remote control system and components used with a remote controlled paint sprayer comprising transmitter 100 and a receiver 102. Transmitter 100 is a remote control unit that is hand-held and designed to communicate with receiver 102. Therein, transmitter 100 may communicate changes to power and pressure for a pressurized paint sprayer (not shown) to a receiver 102, which is in operable control of at least same functions of the paint sprayer. Associated with receiver 102 is antenna 104 having a 2 pin male connector 104a that is matingly received in 2 pin female connector 102a in receiver 102. Transmitter 100 and its components are further described below.

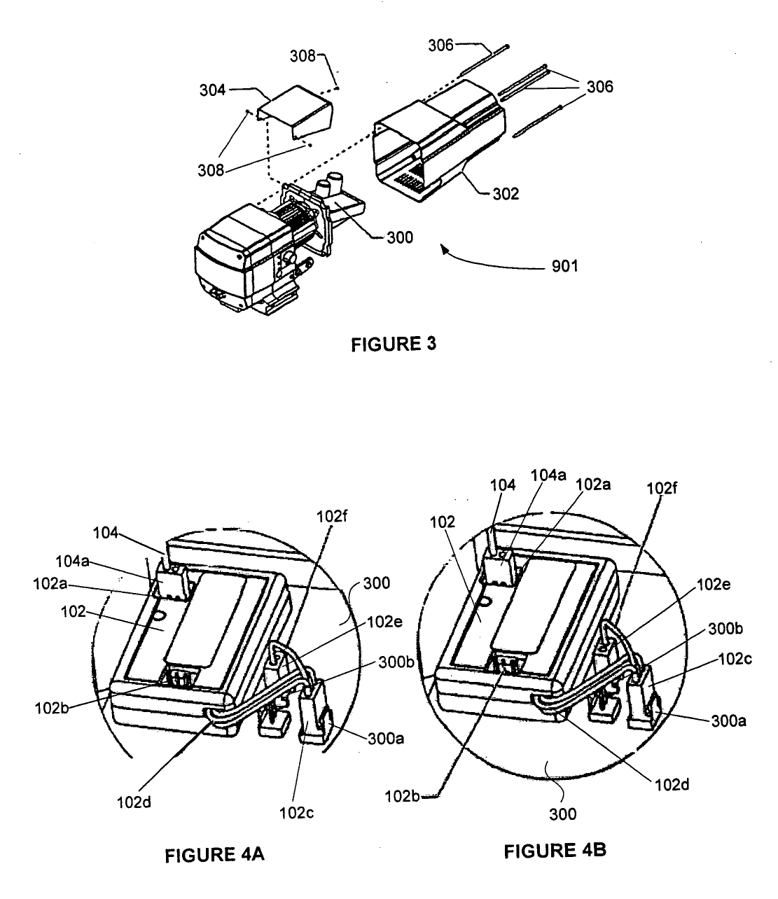

The remote control system 10 illustrated in FIG. 1 may be sold in a paint sprayer system manufactured by the original equipment manufacturer or may be retrofit to an already existing paint sprayer, as described below with reference to FIGS. 2 and 3.

FIG. 2 illustrates pump housing 200 and electrical box 202 of a small sprayer 900 while FIG. 3 illustrates electrical control assembly 300 of a large sprayer. Shown in FIG. 2 are receiver 102, antenna 104, double-sided tape 206, opening 208, grommet 210, and electrical cord 212 with a plug 901 and shown in FIG. 3 are motor shroud 302, electronic cover 304, screws 306 for motor shroud 302, and screws 308 for electronic cover 304.

On small sprayers, receiver 102 is preferably installed inside electrical box 202 on pump housing 200, while on large sprayers receiver 102 is preferably installed on the top of the electrical control assembly 300. In each case, it is preferred that receiver 102 is installed such that electromagnetic (EMF) interference from the engine is minimized or eliminated.

The procedures for the preferred method of installing receiver 102 on a small sprayer by a user is now described with reference to FIGS. 2 and 4. After unplugging electrical cord 212, the mounting screws for the electronic control cover are removed (not shown) and the cover is pulled back for access into electrical box 202. An opening 208 is then drilled through the bottom of electrical box 202 to place antenna wire 104 through the electrical box. Alternatively, a small vent hole or an opening on the bottom of the electrical box may be used for passing a portion of antenna 104 through instead of drilling a new one. Rubber grommet 210 is then inserted into opening 208 to seal opening 208 from the exterior. Antenna wire 104 is then threaded through grommet 210 from inside electrical box 202. Preferably, 8-10 inches of antenna wire 104 hang from the bottom of electrical box 202 and a 2-pin male connector 104a of antenna wire 104 is inside electrical box 202 to be connected to its mate 102a on receiver 102.

A user then locates the potentiometer (not shown) is inside electrical box 202. The 3-pin female connector of the potentiometer should then be unplugged from the EPC board 300, and plugged into the 3-pin male connector 102b on receiver 102. The receiver wire 102d is then plugged into the 3-pin male connector 300a on the EPC board from which the 3-pin female connector was removed using 3-pin female connector 102c, Antenna wire 104 is plugged into the 2-pin female connector 102a on receiver 102. Using double-sided tape 206 or the like, receiver 102 is then secured to the top internal wall of electrical box 202. Finally, the electronic control cover is re-positioned over electrical box 202 and secured with the mounting screws. The jumper wire 102f attached to the receiver wires 102d is plugged in the 2-pin male connector 300b that is typically diagonal from where the receiver wires 102d are plugged in on electronic control assembly 300.

The procedure by a user used to install receiver 102 on a large sprayer with receiver 102 being installed on the top of electronic control assembly 300 is now explained with reference to FIGS. 3, 4a and 4b. Paint sprayer 901 is unplugged and motor shroud screws 306 are loosened and removed to remove motor shroud 302. Also, electronic cover screws 308 are loosened and removed such that electronic cover 304 is lifted off of electronic control assembly 300 on the motor. A user then locates the potentiometer, and unplugs the 3-pin female connector (not shown) from the electronic control assembly 300. As described in FIG. 2, using double-sided tape or the like, receiver 102 is secured to the top of electronic control assembly 300 (not shown). The 3-pin female connector is then plugged into the 3-pin male connector 102b on receiver 102. The receiver wires 102d are then plugged into the 3-pin male connector 300a on electronic control assembly 300 from which the 3-pin female potentiometer connector was removed using 3-pin female connector 102c. The jumper wire 102f attached to the receiver wires 102d is plugged in the 2-pin male connector 300b that is typically diagonal from where the receiver wires 102d are plugged in on electronic control assembly 300.

FIGS. 4a and 4b illustrate a detailed example of the installation of receiver 102 and connection on of jump wire paint sprayer 401. FIG. 4a correlates to the receiver and jumper wire connections described with respect to FIG. 2. FIG. 4b correlates to the receiver and jumper wire connections described with respect to FIG. 3. FIGS. 4a and 4b illustrate wherein there are receiver 102 with antenna wire 104, 3-pin male connector 102b for a potentiometer wire, and receiver wires 102d. If receiver installation is on a small paint sprayer, such as the Titan 740i model paint sprayer by the assignee Titan, jumper wire connector 102e is plugged in so that the wire is in the position closest to receiver wires 102d (see FIG. 4a). If receiver installation is on a large paint sprayer, such as the Titan 840i or 1140i model paint sprayer by the assignee Titan, jumper wire connector 102f is plugged in so that wire 102f is the position furthest from receiver wires 102d (see FIG. 4b).

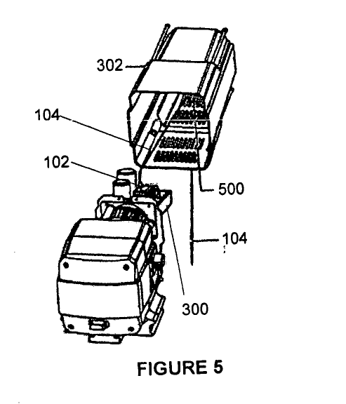

FIG. 5 illustrates a perspective view of the inside of motor shroud 302 in FIG. 3. Provided within motor shroud 302 are rear ventilation slots 500. As shown and previously described, receiver 102 is mounted on electronic control assembly 300. Antenna wire 104 extends from receiver 102 through one of rear slots 500 of motor shroud 302. Preferably, antenna 104 hangs approximately 8-10 inches from the bottom of motor shroud 302, away from metal obstacles (besides the sprayer or its stand). After assembly, when electronic cover 304 is positioned over electronic control assembly 300 and secured, antenna wire 104 is easily accessible.

Controls

FIG. 1 illustrates remote control transmitter 100 in detail. Specifically, FIG. 1 shows the function keys and control keypad on front face 600 of transmitter 100. The function keys and keypad preferably comprise ON button 602, OFF button 604, LED indicator 606, a pressure increase button or PSI UP button 608, and a pressure decrease button or PSI DOWN button 610. Battery cover 612 is also illustrated. Battery cover 612 may, for example, comprise instructions for the device. When transmitter 100 is activated to start painting, pressing ON button 602 will set the spraying pressure to the actual setting of the pressure control knob on the sprayer (not shown). That is, the user must set desired initial pressure for the paint sprayer manually on the paint sprayer, i.e., set the potentiometer so that when a user turns the sprayer on it sets the paint sprayer to the preferred start pressure. Thus, the existing pressure control knob on a sprayer acts as a default pressure to which the sprayer is reset upon switching the control from OFF to ON.

On the other hand, pressing OFF button 604 will set the spraying pressure to 0 psi. Pressing OFF button 604 on transmitter 100 will only decrease the spraying pressure to 0 psi. OFF button 604 will preferably not turn off the sprayer's power.

Pressing the PSI UP button 608 will increase the spraying pressure by any predetermined amount, but preferably 50 psi (pounds per square inch) each time it is pressed. Pressing the PSI DOWN button 610 will decrease the spraying pressure by 100 psi each time it is pressed. Again, other predetermined pressure increments may be used. LED indicator 606 illuminates each time a button on transmitter 100 is pressed, which indicates that a signal is being sent from transmitter 100 to receiver 102.

Transmitter 100 of the present invention requires a 9V alkaline battery for operation, although other batteries may be used. FIG. 1 may be used to illustrate the method used to install a battery into transmitter 100. First, battery cover screws 708 are loosened and removed from transmitter 100, and battery cover 612 is removed. Preferably, a 9V alkaline battery 700 is snapped into cap 704 of transmitter 100. Battery cover 612 is replaced and secured to transmitter 100 with battery cover screws 708. It should be noted that screws 708 should not be over tightened. Also, battery 700 should be removed from transmitter 100 during long-term storage.

Operation

Preferably, the following procedures are used to operate remote control transmitter 100 of the present invention.

Before the first time the remote is used, the receiver 102 must “learn” the address of transmitter 100. This allows receiver 102 to receive signals from the transmitter 100 and control the sprayer. The address is a digital code that the transmitter 100a is USG adjustable. The transmitter uses the digital code to identify the origin of signals sent to the receiver 102. Since the transmitter 100 can be changed, the following procedure method should be performed any time that the transmitter address is changed to allow the receiver to “learn” the new address. First, the paint sprayer should be turned off and a typical pressure relief procedure for a paint sprayer should be performed.

Transmitter 100 should then be held within 2 feet of the sprayer to ensure good reception. Since, receiver 102 is predetermined to be in a learning mode the first 15 seconds after being powered up, once the sprayer is turned on, within the first 15 seconds OFF button 604 on transmitter 100 should be pressed at least 3 times in a row. Receiver 102 will then know the transmitter address. For example, it may be memorized in the receiver's nonvolatile memory such as an EEPROM. Should OFF button 604 not be pressed within 15 seconds of turning on the sprayer, receiver 102 will not be able to “learn” the transmitter address and the above procedure must be repeated. Of course, the learning process described above is just one example of a teaching method between the receiver 102 and transmitter 100. Additional control schemes may also be employed to enable the receiver to “learn” the transmitter address.

General use and operation of the remote control system of the present invention is straightforward. Moving the pressure control knob on the sprayer to the desired initial pressure setting sets up the sprayer. It should be noted that changing the setting of the pressure control knob on the sprayer after using the remote control system will reset the spraying pressure immediately. Movement of the pressure control knob overrides the settings of the remote control system 10, which allows the sprayer to function normally by employing manual controls without use of the remote control system.

After the initial pressure setting is set, the paint sprayer is turned on manually or by pressing ON button 602 of transmitter 100. Spraying may then begin. The spraying pressure is then adjusted to the desired setting by using the controls (ON button 602, OFF button 604, PSI UP button 608, and PSI DOWN button 610) on transmitter 100. The initial switch from OFF to ON causes spraying to start at the spraying pressure set by the pressure control knob. Remote control system 10 preferably operates at distances of up to 100 feet or more and preferably through walls, trees, and other obstacles. The surrounding area, obstacles, and battery life, however, may all affect the operation of transmitter 100. If reception problems occur, transmitter 100 should be pointed in a different direction or may need to be moved closer to the sprayer. If the operational distance of transmitter 100 appears decreases dramatically, the battery in transmitter 100 may need to be replaced. When spraying is complete, the sprayer should be turned off, remembering that pressing the OFF button 604 on the transmitter will decrease the spraying pressure to 0 psi only. The OFF button 604 will not turn off the sprayer's power. Therefore, the sprayer must be manually turned off.

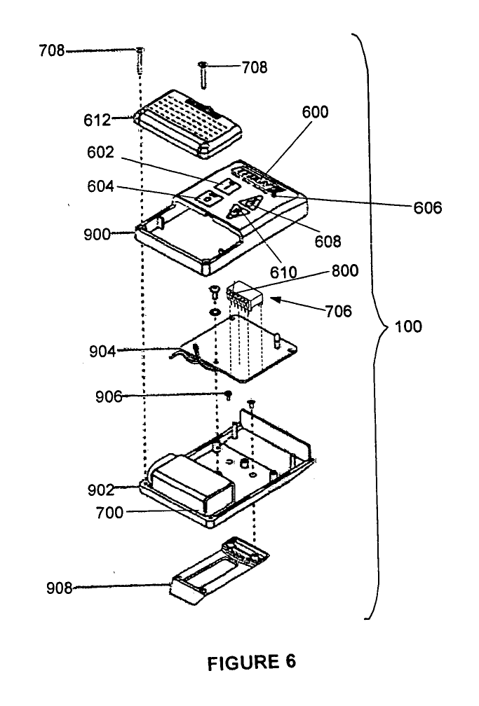

A view of the components of the transmitter is shown in FIG. 6. The housing of transmitter 100 comprises top 900 and bottom 902. Battery 700 and circuit board 904 (with DIP switches 706) are placed and secured within transmitter bottom 902, to be assembled and topped with transmitter top 900 and battery cover 612. Additionally, belt clip screws 906 on transmitter bottom 902 may secure belt clip 908. Belt clip 908 allows a user to secure transmitter 100 to clothing or a tool belt and easily transport remote transmitter 100 to the needed location. Also shown is receiver 102 with antenna 104 and receiver wires 102d that are used to connect to an electronic unit of a paint sprayer.

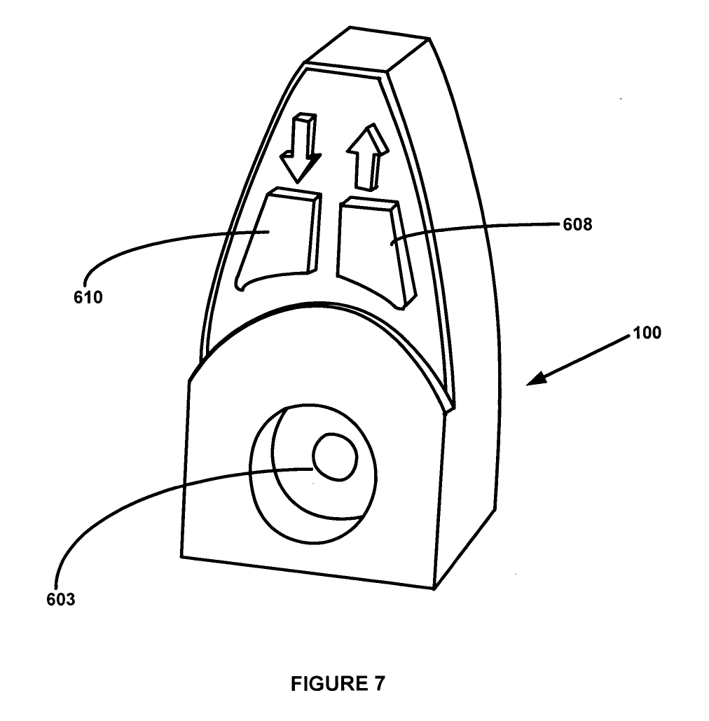

As noted above, the default digital code used as the transmitter address set by the factory can be used in most cases. However, if a problem occurs where there is interference from another transmitter in the area, the digital code should be changed. Battery cover 612 is removed from remote control transmitter 100 by loosening battery cover screws 708. Battery 700 is removed from cap 704 in transmitter 100. DIP switches 706 are then located on the circuit board. Using a pen or similar tool, switch 800 may be pressed such that switch positions are changed (see FIG. 7). Once finished, battery 700 is snapped back into the cap of transmitter 100. Battery cover 612 is replaced and secured by battery cover screws 708. Receiver 102 may then be used to learn the transmitter address as described above (i.e., setting the transmitter address).

While the transmitter 100 has been described and illustrated as a device that is hand-held, such a transmitter may also be associated with a nozzle or spray gun. In other words, the transmitter 100 may be provided with thumb controls that are actively accessible while gripping the spray gun. An example embodiment of a transmitter with controls that may be applied or associated with a nozzle or spray gun is illustrated in FIG. 7 wherein a combined ON/OFF switch 603 is being used to start/stop the sprayer and UP button 608 and DOWN button 610 are disposed to control the pressure of the sprayer.

Remote Control Design Specifications

Remote control transmitter 100 of the present invention transmits a data modulated RF signal, while receiver 102 in the spray painter receives and decodes the RF signal. The technical specification for the design of remote control transmitter 100 and receiver 102, and the data signal are described herein. The preferred electrical specifications for transmitter 100 are set forth in Table 1:

TABLE 1

| | Condition/ | | | | |
|---|---|---|---|---|---|
| Parameter | Description | Min | Typical | Max | Unit |
| Operating Voltage: | | 7.5 | 9 | 10 | VDC |
| Operating Current: | In active mode | | 6 | | mA |
| Frequency: | | | 418 | | MHz |
| Transmitted Power: | | −4 | 0 | 4 | dBm |
| Circuit Type: | SAW Based | | | | |
| | AM module | | | | |

The electrical specifications for receiver 102 transmitter are set forth in Table 2:

TABLE 2

| | Condition/ | | | | |
|---|---|---|---|---|---|
| Parameter | Description | Min | Typical | Max | Unit |
| Operating Voltage: | | | 5 | | VDC |
| Operating Current: | | | 5 | | mA |
| Frequency: | | | 418 | | MHz |
| Sensitivity: | | −92 | −95 | −100 | dBm |
| Circuit Type: | LC Based | | | | |
| | AM module | | | | |

Preferably, the antenna 104 on the receiver 102 is electrically shock safe from the receiver circuitry, which is possibly tied to a non-insulation control circuit (such as the line operated control circuit as used in Titan 740i, 840i and 1140i models by the assignee).

The field of the view transmission distance depends on the output power of the transmitter 100 and the sensitivity of the receiver 102 using modules from LINX Technologies Inc. Preferably, the sensitivity is better than 150 ft in an open field and at least preferably 100 feet under more confined circumstances.

Data Format

The RF control data frame consists of the following elements:
(1) SOF field, consists start bits of frame. SOF indicates the start of transmission.
(2) Address field, consists the information of specified device's address.
(3) Command field, consists the information of specified operation command.
(4) Error control field, consists parity error control bit.

Data Frame (13 bits):

| | | | |
|---|---|---|---|
| SOF | Address | Command | Error Control |

SOF: Start of Frame, two logic 1 bits indicates the start of the transmission frame.
Address Field: 6 bits data of the specified device's address.
Command Field: 4 bits data indicates one of the fifteen control commands.
Error Control: one bit for even parity error control.

The Address Field consists of 6 data bits, which can specify up to total 64 different devices to transmit a control signal. The purpose of this is to avoid the interference between multiple transmitters 100 being used on one job site. If interference between two sets of transmitters 100 and receivers 102 occur, one of the transmitters addresses is change and then reprogrammed to the corresponding receiver.

The control command set is set forth in Table 3:

TABLE 3

| Command Field | Parity Bit | Command | Function |
|---|---|---|---|
| 0000 | 0 | N/U | Not Used |
| 0001 | 1 | ON | Resume the pressure to |
| | | | the preset on the pump |
| 0010 | 1 | UP | Increase the pump pressure |
| 0011 | 0 | | |
| 0100 | 1 | DOWN | Decrease the pump pressure |
| 0101 | 0 | | |
| 0110 | 0 | | |
| 0111 | 1 | | |
| 1000 | 1 | OFF | Set the pressure to zero, |
| | | | override the preset |
| 1001 | 0 | | |
| 1010 | 0 | | |
| 1011 | 1 | | |
| 1100 | 0 | | |
| 1101 | 1 | | |
| 1110 | 1 | | |
| 1111 | 0 | | |

The bit rate of the data frame is 1 ms/bit.

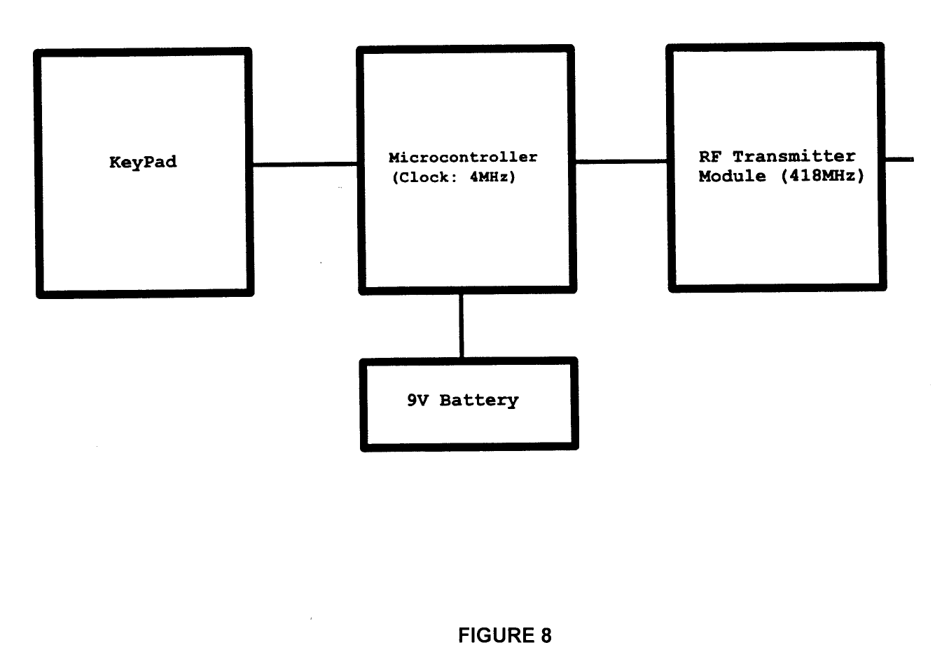

FIG. 8 illustrates a block diagram of the preferred microcontroller used with the preferred embodiment comprising keypad 1100, microcontroller 1102, battery 1104, and RF transmitter module 1106. A Microchip PIC16C711 microcontroller is preferably used with the receiver and transmitter of the present invention. PIC16C71×microcontrollers are low-cost, high performance, CMOS, fully-static, 8-bit microcontrollers with integrated analog-to-digital (A/D) converters. The PIC16C711 has 68 bytes of RAM and 13 available I/O pins.

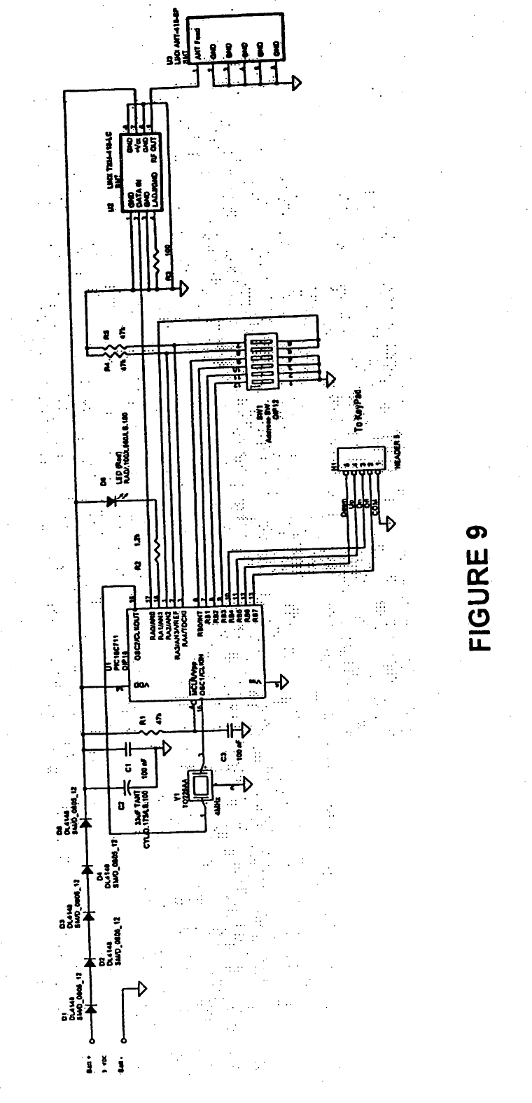

FIG. 9 illustrates a circuit diagram for RF transmitter. In RF transmitter module 1106, i.e. transmitter 100 the preferred assignment of the 13 I/O pins will be as set forth in Table 4:

TABLE 4

| | Pin # | I/O | Buffer | |
|---|---|---|---|---|
| Pin Name | (DIP/SOIC) | Type | Type | Description |
| RA0/AN0 | 17 | O | CMOS | RF Code Output |
| RA1/AN1 | 18 | O | CMOS | LED indicator |
| RA2/AN2 | 1 | I/O | CMOS | Address 5&6 Pull-up |
| | | | | Enable |
| RA3/AN4 | 2 | I | TTL | Address Pin 5 |
| RA4/T0CK1 | 3 | I | TTL | Address Pin 6 |
| RB0/INT | 6 | I | TTL | Address Pin 1 |
| RB1 | 7 | I | TTL | Address Pin 2 |
| RB2 | 8 | I | TTL | Address Pin 3 |
| RB3 | 9 | I | TTL | Address Pin 4 |
| RB4/INT | 10 | I | TTL | Key “ON” |
| RB5/INT | 11 | I | TTL | Key “UP” |
| RB6/INT | 12 | I | TTL | Key “DOWN” |
| RB7/INT | 13 | I | TTL | Key “OFF” |

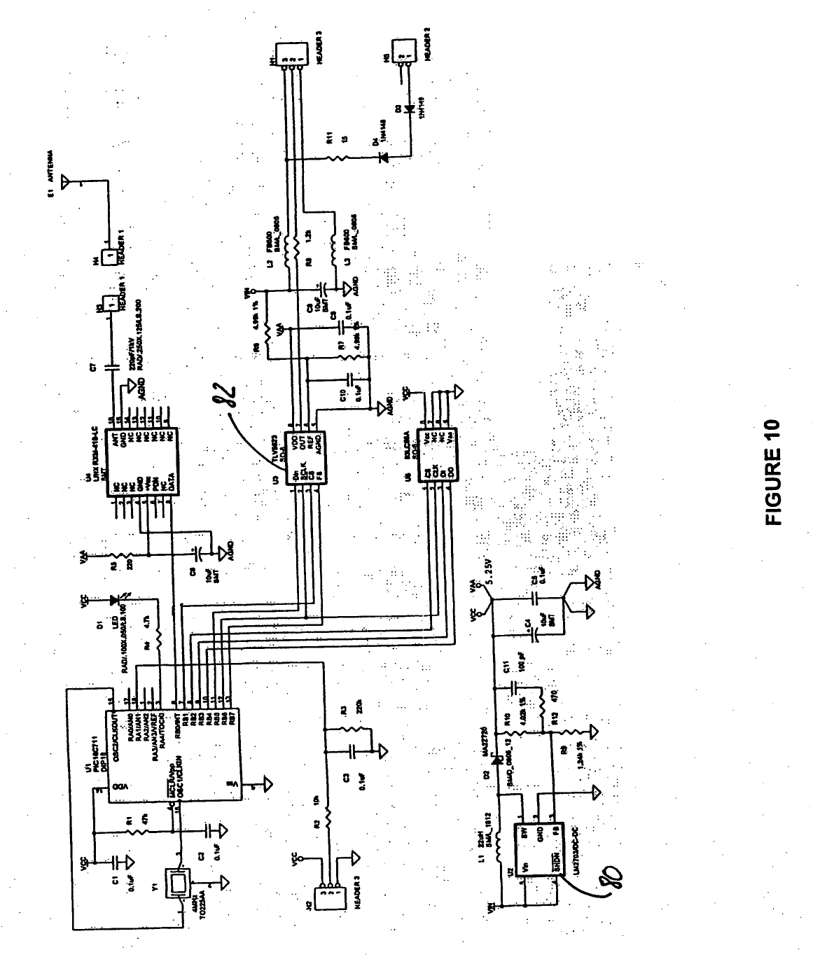

FIG. 10 illustrates circuit diagrams for the RF receiver 102. Therein, power is taken from the potentiometer interface and the operating voltage of the receiver 102 is obtained through the use of a dc-dc converter 80. Receiver 102 outputs a signal via a digital to analog converter 82 to the potentiometer wiper lead on the potentiometer interface. The dc-dc converter 80 allows the digital to analog converter 82 to output the full pressure range without limitation.

In receiver 102, the preferred assignment of the 13 I/O pins will be as set forth in Table 5:

TABLE 5

| | Pin # | I/O | Buffer | |
|---|---|---|---|---|
| Pin Name | (DIP/SOIC) | Type | Type | Description |
| RA0/AN0 | 17 | I | A | NU |
| RA1/AN1 | 18 | I | A | Pressure Control |
| RA2/AN2 | 1 | O | CMOS | NU |
| RA3/AN4 | 2 | O | CMOS | NU |
| RA4/T0CK1 | 3 | O | OC | LED |
| RB0/INT | 6 | I | TTL | RX Data |
| RB1 | 7 | O | TTL | DAC CS |
| RB2 | 8 | O | CMOS | EEPROM CS |
| RB3 | 9 | O | CMOS | Data Out To EEPROM |
| RB4/INT | 10 | I | TTL | Data In From EEPROM |
| RB5/INT | 11 | O | COMS | Data Out to DAC |
| RB6/INT | 12 | O | COMS | DAC/EEPROM Clock |
| RB7/INT | 13 | O | COMS | DAC FS |

The following are some of the envisioned alternate embodiments that may be used in conjunction with remote control system 10 and its components. Transmitter 100 of the invention may operate in a “sleep mode” when not transmitting. To wake up the device, any of the control keys (ON, OFF, and PSI buttons) may be pressed to transmit the corresponding code. The code is in Data Format as specified above, and transmitted twice consecutively to increase reliability. The preferred duration between the two consecutive code frames is 100 ms. Before the transmission of the address, transmitter 100 is able to read the address switch. After transmission, transmitter 100 may return to sleep mode to save battery life.

In an alternate embodiment, a low to high transition causes an external interrupt in activating the receiver micro to buffer the data string at the RF receiver module output. The receiver micro then samples the incoming data string at the same bit rate as transmitter 100. For every transmission from transmitter, if the first data frame is received validly by receiver 102, the second data frame is ignored by receiver 102. After the receiver receives the valid command, the receiver examines the address in the command filed. Only the command with the corresponding address that matches the receiver's memorized address is decoded. For example, An “UP” command received by the receiver causes a corresponding 50 psi increase in pressure output (slow increasing while a “DOWN” command causes a corresponding 100 psi decrease in pressure output (fast decreasing). An “OFF” command sets the pressure output to 0 psi. An “ON” command sets the pressure output to the corresponding potentiometer setting, i.e. control knob settings, located on the paint sprayer.

Preferably, the receiver micro will periodically read the potentiometer setting through its A/D input and output the corresponding digital count to the D/A converter. For example, the receiver micro may read the settings every 195 ms. In this case, any potentiometer setting change greater than 40 psi is updated by the receiver micro digital count output to the corresponding current potentiometer setting. A potentiometer setting change that less than 40 psi does not cause a change to the pressure output. This “debounce” setting prevents fluctuation at the potentiometer output. Preferably, receiver 102 learns and changes addresses as previously described. That is, after the first 15 seconds after receiver 102 is powered, receiver 102 is in learning mode. As previously described, receiver 102 has the ability to learn the transmitter address in learning mode. During the 15-second duration, if receiver 102 receives three consecutive “OFF” commands from transmitter 100, transmitter address will be memorized in the nonvolatile memory such as an EEPROM of receiver 102.

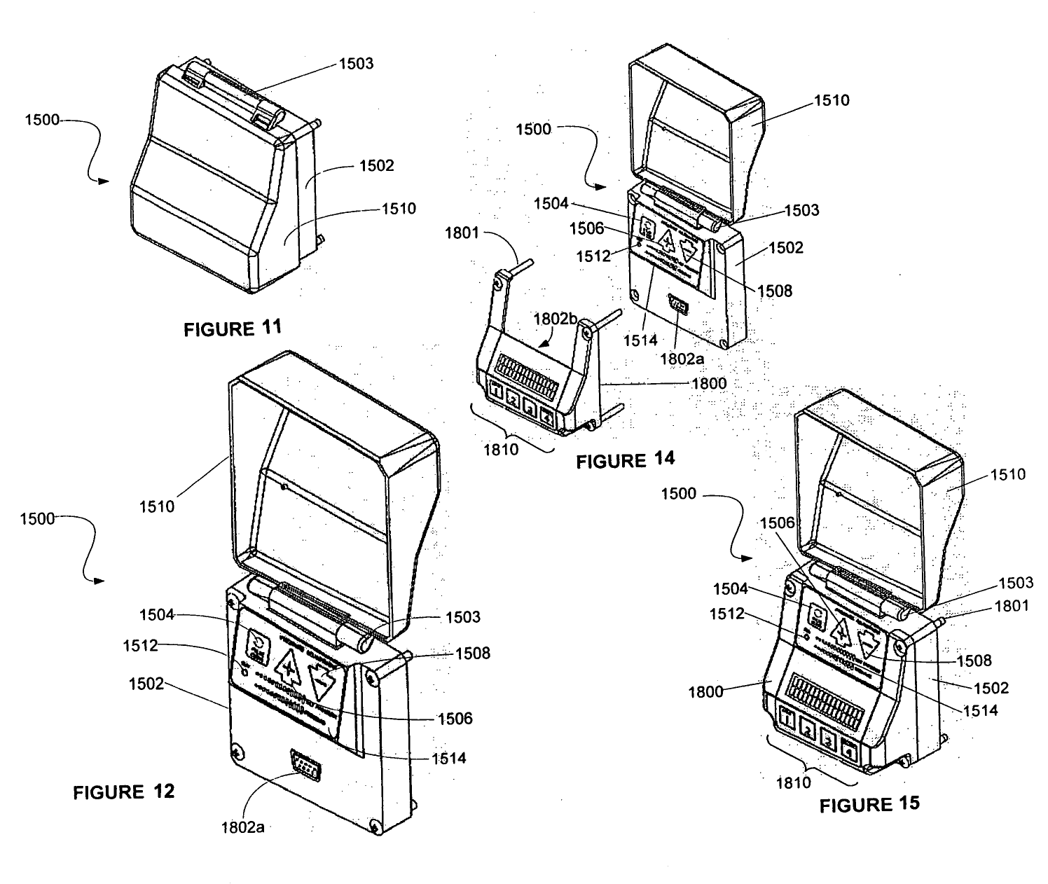

FIGS. 11-12 and 14-15 illustrate an alternative embodiment of remote control system 10 as a stand-alone assembly as well as the assembly of the add-on, upgrade display to the electronic pressure control. Also provided is a method for communicating with the pressure control serially via a connector.

FIG. 11 is a perspective view of an alternative “standard” electronic pressure control transmitter 1500 with its cover 1510 in the closed position. Cover 1510 is hinged via hinge 1503 to body 1502. FIG. 12 illustrates the transmitter 1500 having cover 1504 in the open position thus exposing standard control panel 1502.

A pulse clean function button 1504, a spraying pressure increase button 1506, and a spraying pressure decrease button 1508 are disposed on transmitter 1500. A status indicator display 1512 and a pressure display 1514 are also disposed on transmitter 1500. An interface port 1802a, such as a serial port, is disposed on the front face of transmitter 1500.

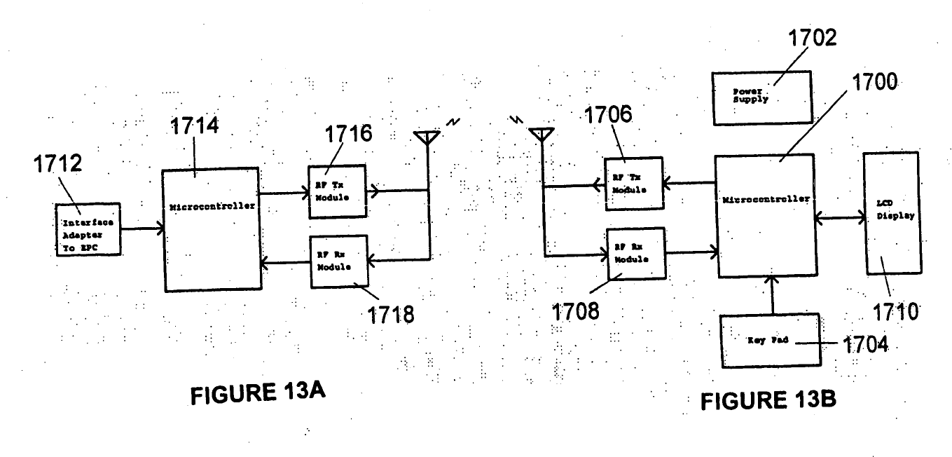

FIG. 13b illustrates block diagrams of the remote section of transmitter 1500 and FIG. 13a illustrates block diagrams of the add-on section 1800 of the transmitter 1500. Transmitter 1500 comprises microcontroller 1700, power supply 1702, keypad 1704, RF transmitter module 1706, RF receiver module 1708, and LCD display 1710. The add-on section 1800 comprises an interface adapter 1712 utilizing interface 1802b disposed to matingly connect with interface port 1802a, microcontroller 1714, RF transmitter module 1716 and RF receiver module 1718.

FIGS. 14-15 illustrate the use of the above described add-on element 1800. As shown in FIG. 14, an additional or add-on display unit 1800 is attached to standard transmitter 1500. Add-on display 1800 preferably comprises compact housing 1802 with digital display and controls. The controls preferably include keypad 1804 with user-selectable keys 1810 labeled I-4 (described below). Once add-on display unit 1800 is secured to transmitter 1500, system 10 operates as described above. Add-on display 1800 comprises an interface 1802b that fits into interface port 1802a. Add-on display 1800 is accommodated within the same cover 1510 as shown in FIG. 15. The combined unit may be assembled as a complete unit to ensure proper fit, such that add-on display 1800 will be placed over the standard electronic pressure control during manufacturing.

If the unit is upgraded in the field, the mounting fasteners of standard control module 1500 would be removed, add-on display 1800 would be positioned over control module 1500 such that the connectors interface make a connection, and the mounting fasteners would be reassembled onto the control module 1500 with add-on display 1800.

FIGS. 14-15 illustrate digital displays on both the standard unit and the add-on unit. However, in one contemplated embodiment of the present invention, the standard unit might be provided with a rotational knob potentiometer and the add-on unit would be provided with a digital display defining an upgrade of the standard unit. The “upgrade” aspect of the add-on display will be explored in more detail below.

The electronic pressure control of the alternate embodiment has on board non-volatile memory for data storage. The data stored is preferably indicated on the communications specifications for a 2003BMPC control board shown by way of example in Table 6. The control system monitors the system pressure and, depending on the pressure set point setting, commands the motor to operate or to terminate operation. This may also occur in clean mode, where the controller will oscillate the motor on and off.

TABLE 6

| | Decimal | | Data | |
|---|---|---|---|---|
| Data | Digits | Bytes | Category | Format |
| SN# | 10 | 5 | A | Decimal Bit [symbol] |
| | | | | Nibble |
| Gallons | 6 | 3 | A | Decimal Bit [symbol] |
| | | | | Nibble |
| Job Gallons | 4 | 2 | A, R | Decimal Bit [symbol] |
| | | | | Binary |
| On Timer hour | 5 | 2 | A | Decimal Bit [symbol] |
| | | | | Binary |
| On Timer minute | 2 | 1 | A | Decimal Bit [symbol] |
| | | | | Binary |
| Run Time hour | 4 | 2 | A | Decimal Bit [symbol] |
| | | | | Binary |
| Run Time minute | 2 | 1 | A | Decimal Bit [symbol] |
| | | | | Binary |
| Job On Time hour | 5 | 2 | A, R | Decimal Bit [symbol] |
| | | | | Binary |
| Job On Time minute | 2 | 1 | A, R | Decimal Bit [symbol] |
| | | | | Binary |
| Job Run Time hour | 4 | 2 | A, R | Decimal Bit [symbol] |
| | | | | Binary |
| Job Run Time minute | 2 | 1 | A, R | Decimal Bit [symbol] |
| | | | | Binary |
| Voltage | 3 | 1 | A | Decimal Bit [symbol] |
| | | | | Binary |
| Service hour | 3 | 2 | A, R | Decimal Bit [symbol] |
| | | | | Binary |
| Run hours | 3 | 2 | A | Decimal Bit [symbol] |
| | | | | Binary |
| Security Code | 4 | 1 | A, R | Decimal Bit [symbol] |
| | | | | Binary |
| Set PSI | 3 (0-255) | 1 | A, U | 8 bit A/D count |
| Act PSI | 3 (0-255) | 1 | A, U | 8 bit A/D count |
| Pre-Set PSI #1 | 3 (0-255) | 1 | A, R | 8 bit A/D count |
| Pre-Set PSI #2 | 3 (0-255) | 1 | A, R | 8 bit A/D count |
| Pre-Set PSI #3 | 3 (0-255) | 1 | A, R | 8 bit A/D count |
| Pre-Set PSI #4 | 3 (0-255) | 1 | A, R | 8 bit A/D count |
| State | | 1 | A | Status bits |

Note:
Data category;
A - Full Information,
U - Updated Information,
R - Resettable Information

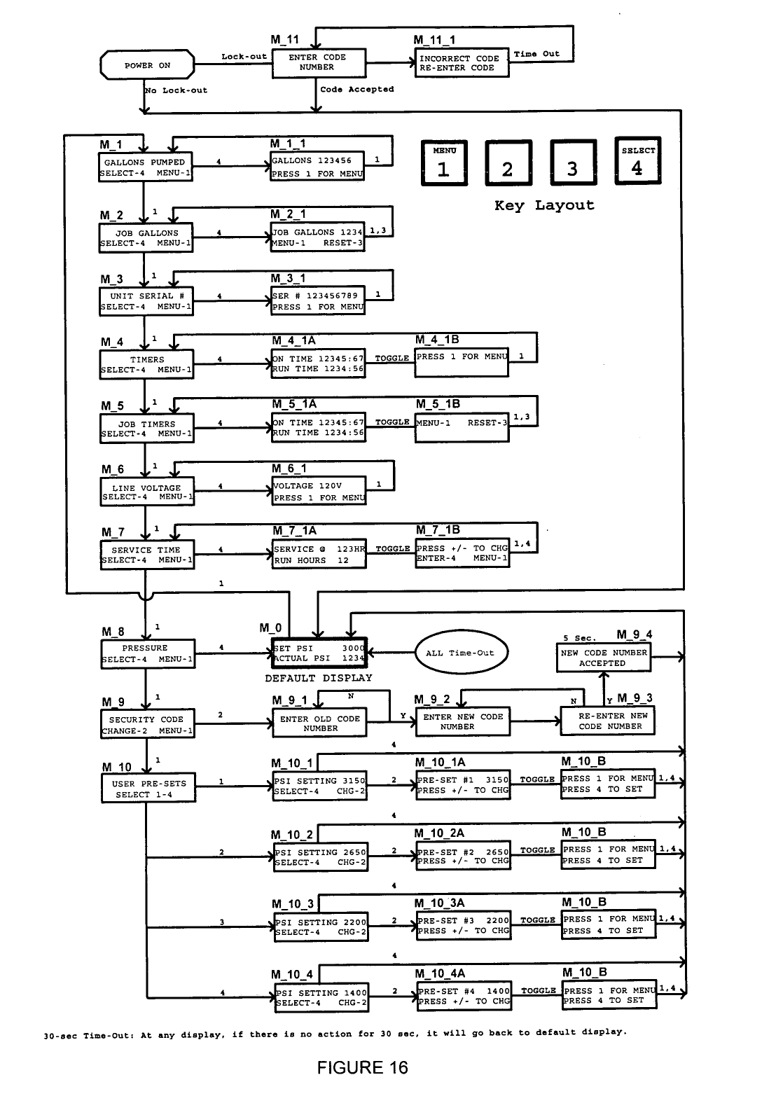

FIG. 16 details the decision-making paths of the add-on display control module. As shown in the operational flowchart of FIG. 16, the add-on display gives the user the ability to maneuver through various menus (designated by the letter “M” on FIG. 16) to read the current pressure setting, gallons pumped, job gallons, serial number, job timers, service timers, other times, the current system pressure, data stored on the electronic pressure control, provide a means to load preset pressure set points (as discussed below), etc. Data is uploaded from the remote control transmitter to the add-on display.

The “Security Code” data line in Table 6 and the “Menu 9-Security Code” block in FIG. 16 illustrate a unique feature consisting of a security lockout system with a digital add-on accessory. In particular, the user is able to establish settings that may only be changed by entering a security code on the digital add-on numbered buttons. More specifically, as shown in FIGS. 14-15, button “1” is preferably designated a “Menu” button, while button “4” is designated a “Select” button. More importantly, the security code may be used to prevent unauthorized access or use of the motor assembly being controlled by the pressure control, whereby a user must enter a code in order to activate the power and vary the pressure settings. This is a lockout feature designated at the top of FIG. 16 by Menu 11 and 11_1. The security code may also be changed by first entering in the existing security code and then modifying the security code as desired.

The “Voltage” data line in Table 6 and the “Menu 6, Line Voltage” block in FIG. 16 illustrate another unique feature of the add-on display consisting of a voltage readout and recording feature that enables recording of voltage changes or spikes in the system as desired.

The “Pre-Set” data lines in Table 6 and the “Menu 10, User Pre-Sets” block in FIG. 16 illustrate another unique feature of the add-on display consisting of user pre-set pressure settings provided on the digital add-on accessory. For example, a user can pre-set different pressures depending on the job requirements, paint type, painted material, paint sprayer configuration and sprayer tip configuration (to name a few). Also in FIG. 16 the “Menu 10, Submenus 1-4” block illustrates various pressure presets such as 1400, 2200, 2650 and 3150 psi. Of course, other pressure presets may be established as desired. The presets may also be used to control aspects of the motor operation other that pressure as desired by the operator.

The remote control system of the alternative embodiment is preferably designed to interface with a motor assembly for a paint delivery system and comprise a pressure transducer, pressure adjustment means and line power. The pressure adjustment means can be accomplished either by a keypad which preferably consists of 3 keys “up, down, clean,” with “set pressure” and “actual pressure” displays as shown in FIGS. 11-12 and 14-15 or by a knob potentiometer that is adjusted to increase, decrease or, if in the proper position, clean.

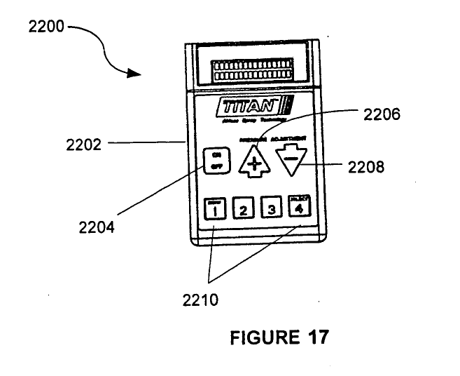

An alternative transmitter embodiment as illustrated in FIGS. 1-10 may also be provided with a digital display and controls as shown in FIG. 17. Preferably, the alternative embodiment is operable with the add-on section of the control system of FIGS. 13a, 13b and 14.

Transmitter 2200 comprises compact housing 2202 with digital display and controls. The controls include ON/OFF key 2204, pressure adjustment keys 2206 (up) and 2208 (down), and keypad 2210 with user-selectable keys labeled 1-4. The digital display and user-selectable keys provide greater functionality, as described above, allowing the user to establish settings that may only be changed by entering a security code on the digital add-on numbered buttons. Transmitter 2200 is used to wirelessly configure and retrieve information from a paint sprayer, as well as remotely operative in a bi-directional manner with paint sprayer via data modulated RF signal (as described in FIGS. 13a and 13b). Thus, all of the functionality provided on the add-on unit (see FIG. 14), usually attached directly to the paint sprayer unit, is now accessible remotely.

The display gives the same information as the existing add-on, preferably 2 lines by 16 character, but is a small LCD display Varitronics that has a version that is about 2 inch wide by 1 inch height. Similar to the communications between the add-on unit and the main unit of the alternate embodiment described in FIGS. 11-15 and illustrated in Table 6, communications between the transmitter and the add-on unit of the embodiment in FIG. 17 include the following data information from Table 7:

TABLE 7

| | Decimal | | Data | |
|---|---|---|---|---|
| Data | Digits | Bytes | category | Format |
| SN# | 10 | 5 | A | Decimal Bit [symbol] |
| | | | | Nibble |
| Gallons | 6 | 3 | A | Decimal Bit [symbol] |
| | | | | Nibble |
| Job Gallons | 4 | 2 | A, R | Decimal Bit [symbol] |
| | | | | Binary |
| On Timer hour | 5 | 2 | A | Decimal Bit [symbol] |
| | | | | Binary |
| On Timer minute | 2 | 1 | A | Decimal Bit [symbol] |
| | | | | Binary |
| Run Time hour | 4 | 2 | A | Decimal Bit [symbol] |
| | | | | Binary |
| Run Time minute | 2 | 1 | A | Decimal Bit [symbol] |
| | | | | Binary |
| Job On Time hour | 5 | 2 | A, R | Decimal Bit [symbol] |
| | | | | Binary |
| Job On Time minute | 2 | 1 | A, R | Decimal Bit [symbol] |
| | | | | Binary |
| Job Run Time hour | 4 | 2 | A, R | Decimal Bit [symbol] |
| | | | | Binary |
| Job Run Time minute | 2 | 1 | A, R | Decimal Bit [symbol] |
| | | | | Binary |
| Voltage | 3 | 1 | A | Decimal Bit [symbol] |
| | | | | Binary |
| Service Set hour | 3 | 2 | A, R | Decimal Bit [symbol] |
| | | | | Binary |
| Service Run hour | 3 | 2 | A | Decimal Bit [symbol] |
| | | | | Binary |
| Security Code | 4 | 1 | A, R | Decimal Bit [symbol] |
| | | | | Binary |
| Pre-Set PSI #1 | 3 (0-255) | 1 | A, R | 8 bit A/D count |
| Pre-Set PSI #2 | 3 (0-255) | 1 | A, R | 8 bit A/D count |
| Pre-Set PSI #3 | 3 (0-255) | 1 | A, R | 8 bit A/D count |
| Pre-Set PSI #4 | 3 (0-255) | 1 | A, R | 8 bit A/D count |
| Set PSI | 3 (0-255) | 1 | A, U | 8 bit A/D count |
| Act PSI | 3 (0-255) | 1 | A, U | 8 bit A/D count |
| State | | 1 | A, U | Status bits |

Note:
Data category;
A - Full Information,
U - Updated Information,
R - Resettable Information

Benefits of Using

As previously mentioned, the remote control transmitter can be operated from over one hundred (100) feet away from the paint sprayer unit—through walls, trees and other obstacles. Thus, you can keep the sprayer clean by not having it in the room that needs painting. The remote control system also enables the operator to increase or decrease the spraying pressure without climbing down off the ladder or scaffold, which reduces fatigue and thus keeps the operator energized throughout the day. The operator can therefore easily increase pressure to get to the top of peaks and decrease pressure around windows and eaves when painting a house, for example. The system also provides the operator with the ability to turn the sprayer's pressure on and off remotely. In addition, it eliminates “run away,” that is, when you run out of paint by stopping the sprayer quickly, thus extending the piston and packing life.

### CONCLUSION

A system and method has been shown in the above embodiments for the effective implementation of a remote control paint sprayer. While various preferred embodiments have been shown and described, it will be understood that there is no intent to limit the invention by such disclosure, but rather, it is intended to cover all modifications falling within the spirit and scope of the invention, as defined in the appended claims. For example, the remote control system described should not be limited to power and pressure parameters, but other parameters may be equally controlled from a distance.

1. A system for remotely controlling a paint sprayer, the system comprising:
a transmitter located remote from the paint sprayer for communicating a command that controls a selected function of the paint sprayer, and
a receiver for receiving the command and being operably connected the paint sprayer so as to cause an execution of the command to control the selected function of the paint sprayer.

2. The system of claim 1 further comprising an antenna operably connected to the receiver for improving reception of the command.

3. The system of claim 2, wherein the receiver is located with a housing of the paint sprayer and at least one portion of the antenna is located outside of the housing of the paint sprayer so as to further improve reception of the command.

4. The system of claim 1, wherein the receiver is operably connected to paint sprayer so as to control the voltage of the paint sprayer.

5. The system of claim 3, wherein the receiver comprises a debounce setting to prevent fluctuation of the voltage.

6. The system of claim 1, wherein the receiver is located within a housing of the paint sprayer.

7. The system of claim 6, wherein the receiver is located within the housing to minimize electromagnetic interference in receiving the command.

8. The system of claim 1, wherein the selected function is one of increasing a spraying pressure of the paint sprayer, decreasing the spraying pressure of the paint sprayer, setting the spraying pressure of the paint sprayer to zero pressure; and setting the spraying pressure of the paint sprayer to a predetermined pressure.

9. The system of claim 1, wherein the transmitter is hand-held.

10. The system of claim 1, wherein the transmitter is attached to a spray gun associated with the paint sprayer.

11. The system of claim 1, wherein the transmitter operates at a distance of at least 100 feet away from the receiver.

12. The system of claim 1, wherein the transmitter has a sleep mode when not transmitting in order to save the battery life.

13. The system of claim 1, wherein the transmitter comprises a rotational knob potentiometer for one of continuously increasing and decreasing a spraying pressure.

14. The system of claim 1 further comprising a cover associated with the transmitter, the cover protecting at least a portion of the transmitter.

15. The system of claim 1, wherein the transmitter comprises a control keypad for choosing the selected function of the paint sprayer.

16. The system of claim 15, wherein the control keypad comprises at least one button for increasing and decreasing a spraying pressure.

17. The system of claim 15, wherein the control keypad comprises
an ON button for increasing a spraying pressure of the paint sprayer to a first set spraying pressure,
an OFF button for reducing the spraying pressure of the paint sprayer to zero pressure,
a first button for increasing the spraying pressure of the paint sprayer, and
a second button for decreasing the spraying pressure of the paint sprayer.

18. The system of claim 17, wherein the first button increases the spraying pressure in increments.

19. The system of claim 18, wherein the increment is an increasing pressure of 50 psi.

20. The system of claim 17, wherein the second button decreases the spraying pressure in increments.

21. The system of claim 20, wherein the increment is a decreasing pressure of 100 psi.

22. The system of claim 15 further comprising a cover associated with the transmitter, the cover protecting at least the control keypad.

23. The system of claim 1, wherein the receiver is operably connected to paint sprayer so as to control a potentiometer of the paint sprayer.

24. The system of claim 1 further comprising an add-on control unit operably connected to the transmitter for providing enhanced functionality, the control unit comprising
a control keypad for one of choosing the selected function of the paint sprayer,
monitoring an unselected function of the paint sprayer, and monitoring a parameter of the paint sprayer; and
a display for displaying a reading associated with one of the selected function of the paint sprayer, the unselected function of the paint sprayer, and the parameter of the paint sprayer.

25. The system of claim 24, wherein the add-on control unit is one of being attachable and being detachable from the transmitter.

26. The system of claim 24, wherein the display is digital.

27. The system of claim 24 further comprising a cover associated with the transmitter to protect at least the add-on control unit.

28. The system of claim 24, wherein the control unit further comprises an authorizing means for preventing misuse of the transmitter.

29. The system of claim 28, wherein the authorizing means comprises a security code for preventing misuse of the transmitter.

30. The system of claim 24, wherein the receiver comprises means for learning the security code so as to permit flexible use of a plurality of transmitters.

31. The system of claim 24, wherein the control unit further comprises a means for displaying a voltage readout on the display and a recording feature for recording of one of voltage changes and spikes in the paint sprayer.

32. The system of claim 24, wherein the control unit further comprises a means for presetting a pressure setting of the paint sprayer.

33. The system of claim 24, wherein the parameter of the paint sprayer is one of gallons of paint pumped, cumulative gallons used, cumulative gallons used in a job, time, and maintenance time elapsed.

34. The system of claim 1 further comprising an authorizing means for preventing misuse of the transmitter.

35. The system of claim 34, wherein the authorizing means is a security code for preventing misuse of the transmitter.

36. A method of installing a remote control system comprising a transmitter, a receiver and an antenna; the remote control system for controlling a paint sprayer having an electrical assembly, the method comprising:
disconnecting the paint sprayer from an electrical power source,
removing a housing cover of the painter sprayer to access the electrical assembly,
connecting the receiver to a potentiometer of the electrical assembly so as to control a voltage of the paint sprayer,
mounting the receiver in an area of the paint sprayer covered by the housing;
connecting an antenna to the receiver to improve reception of a command from the transmitter; and
feeding at least a portion of the antenna through the housing so as to further improve reception of the receiver.

37. The method of claim 36, further comprising the step of feeding the antenna through an opening in the electrical assembly.

38. The method of claim 36, further comprising the step of mounting the receiver in an area of the paint sprayer so as to reduce electromagnetic interference.

39. The method of claim 36, further comprising the step of connecting a potentiometer to the receiver.

40. The method of claim 39, wherein the step of connecting a potentiometer to the receiver further comprises disconnecting the potentiometer from an EPC board.

41. A method of teaching a paint sprayer to identify a transmitter of a remote control system which comprises a receiver, and antenna connected to the receiver, and the transmitter;
the method comprising the steps of:
turning power of the paint sprayer off,
positioning the transmitter near the paint sprayer,
turning the power of the paint sprayer on, and
pressing a button designed to relay the address of the transmitter at least three times within three seconds of powering on the paint sprayer, and
wherein the transmitter address is relayed to, learned by a receiver located within the paint sprayer, and ready for remote control.

42. A method of using a remote control wireless transmitter to electronically control a paint sprayer comprising:
setting an initial pressure on the paint sprayer,
turning on the paint sprayer,
adjusting spraying pressure to a desired setting using a control keypad of the transmitter, and, when spraying is complete,
decreasing the spraying pressure of the paint sprayer,
turning off the paint sprayer, and
wherein the control of the paint sprayer is performed from a distance.
